(19) United States
(12) Patent Application Publication
(10) Pub. No.: US 2011/0280695 A1
(43) Pub. Date: Nov. 17, 2011

(54) Railroad Freight Car Loading Or Unloading

(76) Inventors: David Kun, Federal Way, WA (US); George Chen, Los Gatos, CA (US)

(21) Appl. No.: 12/777,278

(22) Filed: May 11, 2010

(51) Int. Cl. B61D 47/00; B65G 63/00

(52) U.S. Cl. 414/333; 414/800

(57) ABSTRACT

The present invention discloses an apparatus for loading and unloading a container or semi-trailer from a railroad freight car including: a side track located off a main line; a joint in the side track; a segmented rail connected to the joint; and a platform underlying the side track. The present invention further discloses a method of unloading a container or semi-trailer from a L-car including: moving the L-car from a main line to a side track; pivoting a segmented rail to a slant angle relative to the side track; connecting a tractor to the container or semi-trailer; and pulling the container or semi-trailer off the L-car.

### BACKGROUND OF THE INVENTION

1. Field of the Invention

The present invention relates to a field of transportation, and, more specifically, to loading or unloading a railroad freight car.

2. Discussion of Related Art

A load that is being transported across a region may include lading or freight. Freight possessing various sizes, shapes, and weights may be consolidated and packed together in a container or semi-trailer having standard dimensions. The container or semi-trailer may serve to facilitate both secure storage and reliable transportation.

The container or semi-trailer may be transported by different modes of transportation along a journey from an origination point to a destination point. The modes may be by tractor on road, by railroad freight car (rolling stock) on rail, by barge on river or lake, by container ship on sea or ocean, or by cargo airplane in air. In order to conserve space, multiple containers may be stacked. For example, up to seven containers may be stacked on the container ship.

When transported by rail, the container or semi-trailer may be placed on the railroad freight car. Two types of intermodal service are referred to as Container-on-Freight-Car (COFC) service and Trailer-on-Flat-Car (TOFC) service respectively. Unlike for semi-trailers, one container may be stacked, if desired, on top of another container in what is called double-stack COFC service.

The container or semi-trailer may be loaded or unloaded from the railroad freight car starting from one end (called circus loading) of a train. However, a long train is often separated first into multiple sections. Then the individual sections have to be moved to multiple parallel tracks to be loaded or unloaded sequentially.

Alternatively, the container or semi-trailer may be loaded or unloaded from the railroad freight car from one side of a train. In such a case, an overhead crane or a side-lifting fork-lift crane may be used. However, large spaces and expensive equipment are required.

The present invention discloses a method of and an apparatus for directly transferring containers or semi-trailers between any particular railroad freight car and a tractor.

### SUMMARY OF THE PRESENT INVENTION

Accordingly, an object of the present invention is to load or unload a container or semi-trailer from a railroad freight car without operating sequentially from one end of a train.

Another object of the present invention is to transfer freight from a railroad freight car by moving the railroad freight car from a main line to a side track that has a segmented rail that is pivotable.

Still another object of the present invention is to transfer freight from a railroad freight car by moving the railroad freight car from a main line to a side track that has a segmented rail that is removable.

Yet another object of the present invention is to pivot a railroad freight car on, or over, a plate across a platform that is underlying the rails of a side track.

The foregoing and other objects of the present invention are achieved with a system of the present invention that may include a segmented rail (or a curved indent), a plate, and a platform.

The foregoing and other objects of the present invention may be further accomplished with an L-car of the present invention that may include a deck, a dolly attached to the deck, and a fixture attached to the deck to mount above a dolly of another L-car.

The system of the present invention will be more completely understood from the following detailed description of the present invention taken in conjunction with the drawings and the claims.

### BRIEF DESCRIPTION OF THE DRAWINGS

FIG. 1 shows a schematic overhead view of a railroad freight car that may be moved from a main line to a side track having a segmented rail and a platform according to an embodiment of the present invention.

FIG. 2 shows a schematic overhead view of a segmented rail in a side track that may be pivoted or removed to permit a tractor to access a railroad freight car according to another embodiment of the present invention.

FIG. 3 shows a schematic elevation view of a container or semi-trailer carried on an L-car according to still another embodiment of the present invention.

FIG. 4 shows a schematic elevation view of a tractor backing up onto a raised deck to connect to a container or semi-trailer carried on a flatcar according to yet another embodiment of the present invention.

FIG. 5 shows a schematic elevation view of a tractor backingup on a road to connect to a container or semi-trailer carried on an L-car according to a further embodiment of the present invention.

### DETAILED DESCRIPTION OF THE PRESENT INVENTION

In the following description, numerous details, examples, and embodiments are set forth to provide a thorough understanding of the present invention. However, it will become clear and apparent to one of ordinary skill in the art that the invention is not limited to the details, examples, and embodiments set forth and that the invention may be practiced without some of the particular details, examples, and embodiments that are described. In other instances, one of ordinary skill in the art will realize that certain details, examples, and embodiments that may be well known have not been specifically described so as to avoid obscuring the present invention.

The present invention envisions an apparatus for and a method of loading or unloading freight from a train on a railroad. A standard gauge for the track of the railroad in North American is 4 feet 8.5 inches.

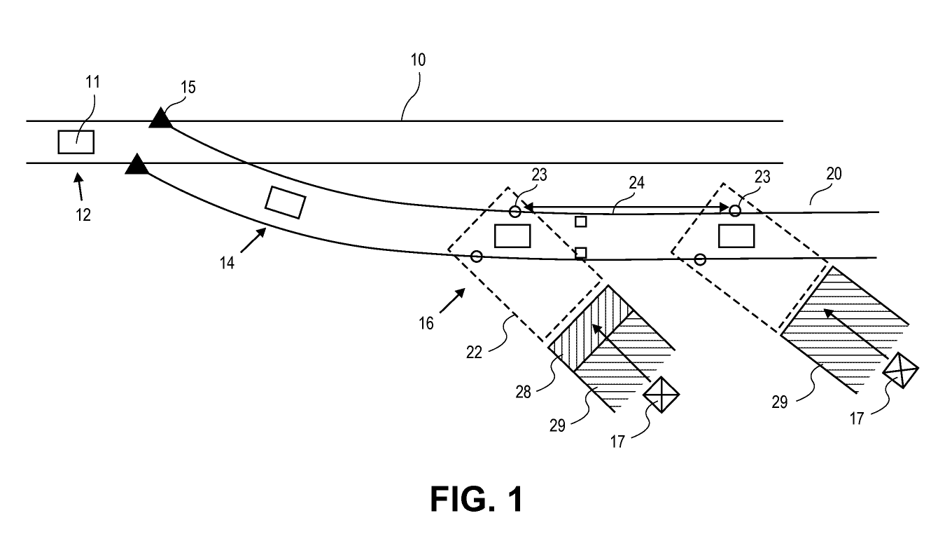

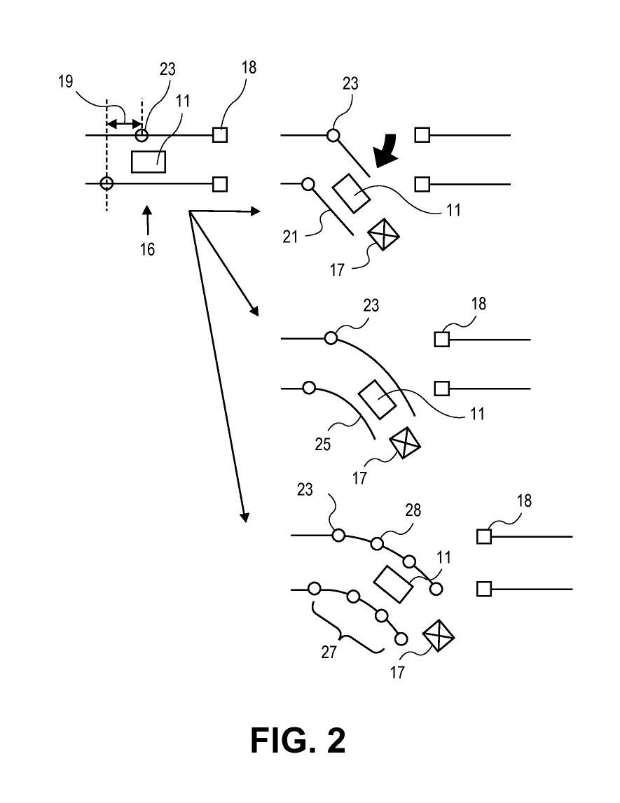

As shown in an embodiment of the present invention in FIG. 1, an apparatus for transferring a container or a semi-trailer 11 between a railroad freight car on a side track 20 and a tractor 17 on an adjacent road 29 will be described first. According another embodiment of the present invention in FIG. 2, the apparatus may include a segmented rail 21 that is removable or pivotable, such as temporarily, to access, such as directly, the side track 20 at one or more positions 16 along its length.

Lading or freight may be stored and transported in a container or a semi-trailer 11. In most cases, the container or semi-trailer 11 has dimensions that are standardized, such as by the International Standards Association (ISO).

Typical lengths of the container are 20, 40, 45, 48, and 53 feet. Typical widths of the container are 8 and 8.5 feet. Typical heights of the container are 4.25, 8, 8.5, 9.5, and 10.5 feet. The container may be attached to an underlying chassis that may include wheels.

Typical lengths of the semi-trailer 11 are 24, 28.5, 40, 48, 50, and 53 feet. The Department of Transportation (DOT) in the US specifies that a vehicle comprising a tractor 17 pulling a load of 1, 2, or 3 semi-trailers 11 should not exceed a length of 85-89 feet, with a typical width of 8.5 feet, and a typical height of 13.5 feet. Each semi-trailer 11 may include one set of wheels towards the rear and landing gear (legs which may be unfolded and lowered to the ground to provide support when the semi-trailer 11 is decoupled from the tractor 17) towards the front.

In an embodiment of the present invention as shown in FIG. 4, the railroad freight car in the train may include a flatcar 31. The flatcar 31 may include 1-2 dollies (or trucks or bogies) attached towards a rear and another 1-2 dollies attached towards a front. Such a flatcar 31 would thus have a total of 2-4 dollies to travel on rail. Each dolly may include 1-3 axles.

Each dolly may include an assembly that swivels horizontally to more easily negotiate or go around curves on the railroad. The assembly may house 1, 2, or 3 axles. Each axle may include 2 or 4 wheels. For example, a dolly with a two-axle assembly having 2 wheels per axle may have a wheelbase of 5.25-6 feet.

In another embodiment of the present invention, the dolly includes a swiveling assembly, but the left and right wheels are separately attached (not shown) without being connected with an axle. The absence of an axle allows the left and right wheels to be staggered relative to each other. The absence of an axle also allows the wheels to adjust to any change in gauge of the rails.

In an embodiment of the present invention, the flatcar 31 may include a midsection that is telescoping (not shown). The mid-section need not be exactly in the middle of the flatcar 31. For example, the partition for the midsection may occur between 40% and 60% of the total length. A telescoping midsection allows the flatcar 31 to change its length. In one case, the flatcar 31 has a minimum length when it is empty so as to conserve space and result in a shorter train. In another case, the flatcar 31 has a medium length so as to carry a short container, such as with a length of 20 feet, In still another case, the flatcar 31 has a maximum length so as to carry a long container, such as with a length of 53 feet.

In another embodiment of the present invention, the flatcar 31 may include a midsection that is pivoting (not shown). The mid-section need not be exactly in the middle of the flatcar 31. For example, the partition for the midsection may occur between 40% and 60% of the total length. In one case, a pivoting midsection allows the flatcar 31 to bend horizontally as it enters or exits a curve in the rails. In another case, the pivoting midsection allows the flatcar 31 to flex vertically as it goes uphill or downhill on the rails.

In still another embodiment of the present invention, the flatcar 31 may include a midsection that is flexible (not shown) and not entirely rigid. The mid-section need not be exactly in the middle of the flatcar 31. For example, the partition for the midsection may occur between 40% and 60% of the total length. In one case, a flexible midsection allows the flatcar 31 to absorb forces and torques induced as it enters or exits a curve in the rails. In another case, the flexible midsection allows the flatcar 11 to absorb forces and torques as it goes uphill or downhill on the rails.

In an embodiment of the present invention, the flatcar 31 may include an undercarriage that is isolated, or separated, from an upper bed or deck. Such a separated, or independent, undercarriage (not shown) may accommodate a midsection that is telescoping (not shown) or a midsection that is pivoting (not shown). Consequently, stresses will be isolated from, and prevented from transferring to, the load being carried, including the container, such as on a chassis, or the semi-trailer 11. The stresses may be tensile, compressive, or bending.

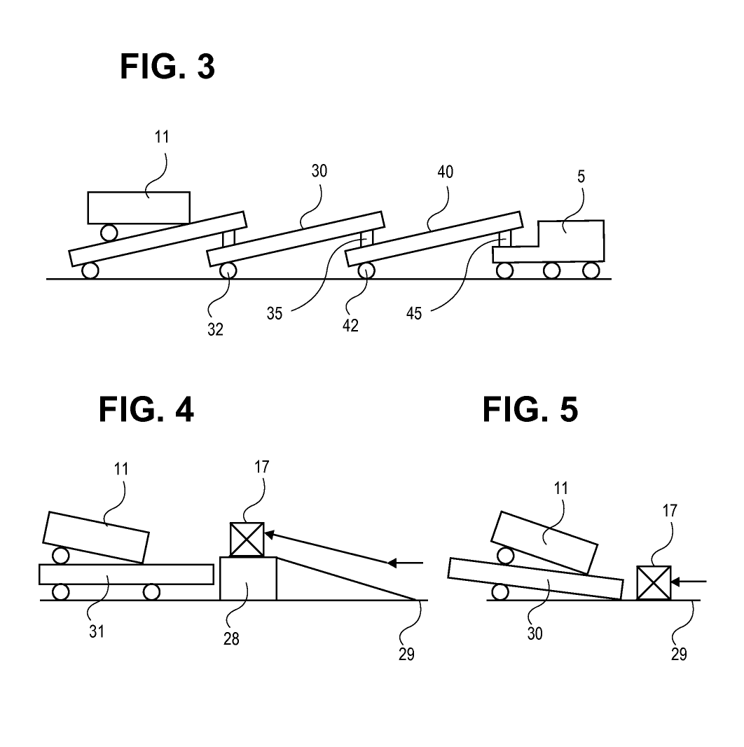

In an embodiment of the present invention as shown in FIG. 3, the railroad freight car in the train may include an L-car 30. The L-car 30 disclosed in the present invention may include one dolly 32 attached towards a rear and one fixture 35 attached towards a front. The dolly 32 may include a swiveling assembly of 1, 2, or 3 axles. When assembled as part of a string in a train, the L-car 30 includes the dolly 32 (in rear) to travel on rail and the fixture 35 (in front) to mount above the (rear) dolly 42 of another L-car 40 located in front.

In other embodiments, the L-car 30 may include one or more of the features previously described for the flatcar 31, such as a telescoping midsection, a pivoting midsection, a flexible midsection, and an independent undercarriage. As needed, the particular features for the flatcar 31 may be changed, modified, or customized, for the L-car 30.

A particular lateral displacement between the fixture 35 of the L-car 30 and the dolly 42 of another L-car 40 in front may be adjusted depending on anticipated, or actual, loading factors. In a first case as shown in FIG. 3, the fixture 35 of the L-car 30 may be mounted directly over the dolly of the L-car 40 located in front. In a second case, the fixture 35 of the L-car 30 may be mounted behind (not shown) the dolly 42 of the L-car 40 located in front. In a third case, the fixture 35 of the L-car 30 may be mounted in front (not shown) of the dolly 42 of the L-car 40 located in front. In a fourth case, the fixture 35 of the L-car 30 may be mounted, such as asymmetrically, including to one side, such as left or right side, (not shown) of the dolly 42 of the L-car 40 located in front.

In one case, the lateral adjustment may be static (constant or fixed), such as performed empirically with a mechanical mechanism. In another case, the lateral adjustment may be dynamic, such as performed in real time (when the L-car 30 is moving over the rail) with a feedback mechanism, such as a gyroscope or a computer.

A particular vertical displacement between the fixture 35 and the dolly 42 may be adjusted to determine a desired tilt. According to the present invention, the L-car 30 has a bed, or deck, that may be inclined, or tilted, at a nominally specified angle, such as selected from minus 15 (tilted forwards) to plus 20 degrees (tilted backwards) relative to a plane of the two underlying rails located below the L-car 30. More typically, the tilt may be selected from minus 9 (tilted forwards) to plus 12 degrees (tilted backwards) relative to the plane of the two underlying rails located below the L-car 30.

In one case, the upper surface of the deck of the L-car 30 may be curved or contoured, such as with a depression or well. In another case, the upper surface of the deck of the L-car 30 may be uneven, such as with lowered areas, such as troughs or trenches, alongside raised areas, such as bumps or mounds. In still another case, the upper surface of the deck of the L-car 30 may be textured, but predominantly flat. In yet another case, the surface of the deck of the L-car 30 may be substantially flat. If desired, the upper surface of the deck of the L-car 30 may include other attachments, such as hooks, clamps, tethers, ropes, chains, blocks, winches, pulleys, nettings, and tarpaulins to secure, or otherwise limit or control movement, of the container, such as on a chassis, or the semi-trailer 11. When appropriate, the attachments may be recessed, hidden, covered, or retractable, in or below the upper surface of the deck of the L-car 30.

When desired, the deck of the L-car 30 may be tilted backwards such that the dolly 32 end is lower than the fixture 35 end. As shown in FIG. 3, the tilted deck of the L-car 30 may compensate, partially or completely, for a difference in height, or elevation, between a rear and a front of the container, such as on the chassis, or the semi-trailer 11.

In one case, the vertical adjustment may be static (constant or fixed), such as performed empirically with a mechanical mechanism. In another case, the vertical adjustment may be dynamic, such as performed in real time (when the L-car 30 is moving over the rail) with a feedback mechanism, such as a gyroscope or a computer.

The fixture 35 is designed to accommodate various types of motion, including pitch, roll, and yaw, that may occur individually or in combination as the L-car 30 moves along the rails. The fixture 35 is also designed to accommodate any dynamic loading that may result from any increase or decrease in slack between any two consecutive L-cars, such as 30 and 40.

In an embodiment of the present invention, the fixture 35 in the front of the L-car 30 may include a universal joint (not shown). The universal joint may pivot in 2 or 3 axes. The fixture 35 may further include a clasping and unclasping mechanism. The fixture 35 may still further include a locking mechanism. The fixture 35 may yet further include a quick-release mechanism.

The fixture 35 may include a coupler or hitch. The fixture 35 may have a low profile. In an embodiment of the present invention, the fixture 35 in the front of the L-car 30 may include a self-aligning head, a U-shaped receptacle, a 270-degree pivoting pin, a quick-release locking system, two sliding skid (or pressure) plates, and spherical axial bearings.

The fixture 35 in the front of the L-car 30 may be operated pneumatically, hydraulically, or electrically. The fixture 35 in the front of the L-car 30 may be designed to fail safely, such as in a closed or locked configuration. When desired, such as in an emergency situation, the fixture 35 in the front of the L-car 30 may be operated manually.

When transported by rail, the container, such as on a chassis, or the semi-trailer 11 may be placed on the railroad freight car. The railroad freight car may include the flatcar (31 in FIG. 4) or the L-car (30 in FIG. 3). A large number, such as 75-225, of railway freight cars may be coupled together in a string in the train.

The string may be pushed or pulled by a consist of multiple locomotives 5, such as 2-6 locomotives 5 in a lash-up set. For example, a diesel-electric locomotive 5 may be powered by a diesel engine connected to a DC (generator) or an AC (alternator) traction motor. Each locomotive 5 may include multiple axles, such as 6-8 axles.

At various stages of the journey across the region, the railway freight cars in the string may be rearranged. Rearrangement is performed at a railroad yard, also known as a switch yard or a freight yard. The railroad yard is located at a strategic point along a main line 10. For efficiency, as well as safety, the main line may be separated into an up yard and a down yard, designating opposite directions of local travel.

The railroad yard may form part of a large freight yard complex. The railroad yard may be divided into a receiving yard, a classification yard, a departure yard, a repair yard, and an engine house. The railroad freight cars may be inspected in the receiving yard. When necessary, the railroad freight cars may be maintained or serviced in the repair yard. Subsequently, the railroad freight cars may be assembled in the departure yard. For a long haul trip, such as may be divided into shifts of up to 12-hours, the crews of the locomotives may be changed in the railroad yard, such as upon direction of a dispatcher for the railroad company.

The railroad freight cars may be rearranged or sorted in the classification yard. Classification may include by railroad freight car owner (or company), by origination point, by destination point, or by railroad freight car type. If desired, a particular block of railroad freight cars (referred to as a unit train) may be kept together in any move around the railroad yard.

In order to perform the classification, one or more of the railroad freight cars may be moved by a specially designed locomotive, such as a switcher, operated by a hostler. The switcher is small and slow, but it is powerful and reliable, has good visibility in all directions, and is maneuverable in both a forward and a rearward direction.

As shown in an embodiment of the present invention in FIG. 1, one (or more) of the railroad freight cars carrying the container, such as on the chassis, or the semi-trailer 11 on a main line 10 may be shunted by a switch 15 to be moved up or down a side track (or siding) 20 that may be laid out in parallel to the main line 10.

Classification may also be performed in conjunction with a specific operation. An operation may be to load or unload the railroad freight car. Another operation may be to repair the railroad freight car. Still another operation may be to add or remove the railroad freight car from the string of the train.

According to the present invention, a method is available for adding or removing containers or semi-trailers 11 from the railroad freight cars at the railroad yard. In particular, the present invention discloses a method of directly transferring a container or a semi-trailer 11 between any specified railroad freight car on a side track 20 and a tractor 17 on an adjacent road 29.

Next, various embodiments of the method of loading or unloading a railroad freight car in the train will be described. As shown in FIG. 1, a string (not shown), including a railroad freight car is moved, such as by a switcher, from a main line 10 to a side track 20. The side track 20 is connected to the main line 10 by a switch 15 that has 2 selectable positions. In one case, the side track 20 may be a dead-end spur that is predominantly parallel to the main line 10. In another case, the side track 20 may be a closed loop that eventually connects back to the main line 10.

The container, such as on the chassis, or the semi-trailer 11 is carried on the flatcar 31 (not shown) or the L-car 30 (in FIG. 3), that moves from a position 12 on the main line 10 to a position 14 on the side track 20 (where the main line 10 and the side track 20 are not parallel), and then to a position 16 on the side track 20 (where the main line 10 and the side track 20 are parallel).

According to the present invention as shown in FIG. 2, the side track 20 includes a segmented rail 21. In one case, the segmented rail 21 may include a straight member. The segmented rail 21 may have a length, such as selected from a range of 3-12 feet. In one case, the segmented rail 21 has a length of about 4 feet. The segmented rails 21 for the two rails may differ in length.

As desired, the side track 20 may include a periodic series of segmented rails 21. The periodicity may correspond to a length of the flatcar 31 (not shown) or the L-car 30 (in FIG. 3). In one case, the periodicity of the segmented rails 21 may be regular such as to accommodate a constant (or fixed) length of the railroad freight cars. In another case, the periodicity of the segmented rails 21 may be irregular, such as to accommodate variable lengths of the railroad freight cars.

In one case, the segmented rails 21 in the periodic series may be contiguous (without any spacing). In another case, the segmented rails 21 in the periodic series may be non-contiguous, such as separated by a spacing 24 between consecutive hinges 23. In one case, the spacing 24, when present, may be constant (or fixed). Alternatively, in another case, the spacing 24, when present, may be variable.

In one case, as shown in FIG. 2, the segmented rail 21 may be pivotable at a hinge 23. The hinges 23 on the two rails may be separated by an offset distance 19 along the rail.

In a closed position, the segmented rail 21 is aligned with the side track 20 with a slant angle (not shown) of zero degree. In an opened position, the segmented rail 21 is slanted relative to the side track 20 with a slant angle, such as selected from a range of 30-60 degrees. The segment rails 21 for the two rails may differ in length.

In one case, the operation, such as pivoting, of the hinge 23 may be performed pneumatically. In another case, the operation, such as pivoting, of the hinge 23 may be performed hydraulically. In still another case, the operation, such as, pivoting of the hinge 23 may be performed electrically. In yet another case, the operation, such as pivoting, of the hinge 23 may be performed manually, such as by pulling, such as on a chain (not shown) that is attached, permanently or temporarily, to the segmented rail 21, such as with a hook.

The segmented rail 21 may further include a clasping and unclasping mechanism. The segmented rail 21 may still further include a locking mechanism. The segmented rail 21 may yet further include a quick-release mechanism.

In another case, the segmented rail 21 may be removable at the hinge 23. In a closed position, the segmented rail 21 is aligned in a straight line with the side track 20. In an opened position, the segmented rail 21 is disconnected (or separated) between the joint 23 and the joint 18, removed, and replaced with a curved indent 25 that is slanted, at its end (or tip), relative to the side track 20 with a slant angle of about 45 degrees. The curved indent 25 for the two rails may differ in length.

In still another case, the segmented rail 21 may include an articulated member 27, such as with multiple joints 28. As needed, the articulated member 27, such as with multiple joints 28, may physically conform to an underlying change in topography, such as a slope.

The articulated member 27 may be pivotable at the multiple joints 28. The curvature of the articulated member 27 may be increased (to a smaller radius) or decreased (to a larger radius) by adjusting the joints 28 in the articulated member 27 relative to each other. In a closed position, the articulated member 27 is aligned in a straight line (to an infinitely large radius) with the side track 20. In an opened position, the articulated member 27 is curved at its end (or tip) relative to the side track 20 with a slant angle, such as about 45 degrees. The articulated members 27 for the two rails may differ in length.

As shown in FIG. 1, one hinge 23 of the segmented rail 21 may be connected to an underlying block or platform 22. The platform 22 may be formed from concrete. The platform 22 may be located between (or next to) the rails in the side track 20.

In one situation, the platform 22 may be discontinuous along an axis that is parallel to the rails in the side track 20. In one case, the gaps between (the hinges 23 connected to) the consecutive platforms 22) may be constant (or fixed).

In another case, the gaps between (the hinges 23 connected to) the consecutive platforms 22 may be variable.

In another situation, instead of being distinct (and separated), the platforms 22 may be joined together and continuous (not shown) along the axis that is parallel to the rails in the side track 20.

In one case, the segmented rail 21 may be slidable along part, or all, of its length. In one situation, the segmented rail 21 may slide or glide, on or over, and across a plate (not shown). The plate may be formed from metal. The metal may reduce sliding friction, when compared to concrete. The plate may be attached to the underlying block or platform 22.

The platform 22 may vary in shape. The platform 22 may vary in lateral dimensions (or size). The platform 22 may vary in thickness. The platform 22 may be partially buried or located entirely below grade. In one case, the plate may have the same shape and lateral dimensions (or size) as the platform 22.

The flatcar 31 (not shown) or L-car 30 (in FIG. 3), with or without the container, such as on the chassis, or the semi-trailer 11, may be transferred or moved, such as by a fork-lift truck (not shown). In one case, the flatcar 31 (not shown) or L-car 30 (in FIG. 3) is lifted and turned, such as with the fork-lift truck (not shown). In another case, the flatcar 31 (not shown) or L-car 30 (in FIG. 3) is rolled on the segmented rail 23, such as with the fork-lift truck. In still another case, the flatcar 31 (not shown) or L-car 30 (in FIG. 3) is dragged on, or over, and across the plate (not shown) on the platform 22, such as with the fork-lift truck. In yet another case, the container, such as on a chassis, or the semi-trailer 11 carried on the flatcar 31 (not shown) or L-car 30 (in FIG. 3) is lifted and turned, such as with the fork-lift truck. In a further case, the container, such as on a chassis, or the semi-trailer 11 carried on the flatcar 31 (not shown) or L-car (in FIG. 3) is shifted and lowered.

If the flatcar 31 is used, a tractor 17 may back up on an adjacent road 29 onto a raised deck 28. as shown in FIG. 1 and FIG. 4. However, if the L-car 30 is used, the tractor 17 may back up directly on the adjacent road 29 as shown in FIG. 1 and FIG. 5 and the raised deck would not be needed. In both cases, the fixture 35 should be accessible to the tractor 17 although some degree of tilt of the container, such as on a chassis, or the semi-trailer 11 may be present.

Gravity may help to move the flatcar 31 or the L-car 30 on the rail of the side track. Gravity may also be used to help load or unload the flatcar 31 or the L-car 30. The ground over which the segmented rail 21 is located may be graded, such as with a slope. An extent of levelness of the orientation of the container, such as on a chassis, or the semi-trailer 11 on the flatcar 31 or the L-car 30 thus depends on various factors, such as (a) whether a slope is present (on the ground) and (b) whether the (tilted) L-car 30 is used.

The tractor 17 may be used to connect to the unloaded container, such as on the chassis, or the semi-trailer 11 that is on the flatcar 31 or L-car 30. The connection between the tractor 17 and the container, such as on the chassis, or the semi-trailer 11 may also include the same fixture 35, as described previously, that connects two L-cars 30, 40.

The tractor 17 may move, such as pull, the unloaded container, such as on the chassis, or the semi-trailer 11 off the flatcar 31 or L-car 30. The tractor-trailer (a combination of the tractor 17 and the unloaded container, such as on the chassis, or the semi-trailer 11) may then continue its journey on the road 29. The trip of the tractor-trailer may include various distances up to about 3,000 miles. However, a typical distance would be less than 500 miles.

In an embodiment of the present invention, two containers may be stacked (referred to as a double-stack) on the flatcar 31 or L-car 30. In order to meet a maximum height limitation inside tunnels and under certain bridges, the double stack may sit in a well (referred to as a fish belly), on the flatcar 31 or L-car 30.

When two containers are stacked, several procedures are available for loading or unloading according to the present invention. In one procedure, a fork-lift truck, or a crane, is used to lift the upper container off the lower container onto a front-back distinct location, such as a forward portion of the segmented rail. In another procedure, the fork-lift truck, or the crane, is used to lift the upper container off the lower container onto a right-left distinct location, such as on an adjacent segmented rail 21. The lower container may then be moved subsequently.

In an embodiment of the present invention, two containers, such as 10-20 feet long each, may be carried in tandem on a single flatcar 31 or L-car 30. In such a situation, several procedures are available for loading or unloading according to the present invention. In one procedure, a fork-lift truck, or a crane, is used to lift the front container to a front-back distinct location, such as a forward portion of the segmented rail. In another procedure, the fork-lift truck, or the crane, is used to lift the front container to a right-left distinct location, such as an adjacent segmented rail. The rear container may then be moved subsequently.

If desired, multiple trailers may be connected together and pulled by a single tractor 17. Such tractor-trailer combinations include so-called A-G road trains. The road trains may further include variations that are called doubles, triples, and quads. One such embodiment with good inherent stability is referred to as a B-Train.

In one embodiment of the present invention, the unloaded (and empty) flatcar 31 or L-car 30 may be left on the segmented rail 21, such as on the plate (not shown) on the platform 22, until freight, such as a container, on a chassis, or a semi-trailer 11, is loaded.

In another embodiment of the present invention, the unloaded (and empty) flatcar 31 or L-car 30 may be moved back to the side track 20 by reversing the operations with the segmented rail 21, such as on the plate (not shown) on the platform 22.

As desired, the portion of the string of the train remaining on the side track 20 may be moved up or down the side track 20 without interrupting, or being interrupted by, any unloading (or loading) of the flatcar 31 or L-car 30 on the segmented rail 21, such as on the plate (not shown) on the platform 22.

Many embodiments and numerous details have been set forth above in order to provide a thorough understanding of the present invention. One skilled in the art will appreciate that many of the features in one embodiment are equally applicable to other embodiments. One skilled in the art will also appreciate an ability to make various equivalent substitutions for those specific materials, processes, dimensions, concentrations, etc. described herein. It is to be understood that the detailed description of the present invention should be taken as illustrative and not limiting, wherein the scope of the present invention should be determined by the claims that follow.

We claim:

1. An apparatus for loading and unloading a container or semi-trailer from a railroad freight car comprising:
a side track disposed off a main line;
a hinge in said side track;
a segmented rail connected to said hinge; and
a platform underlying said side track.

2. The apparatus of claim 1 wherein said segmented rail is removable.

3. The apparatus of claim 1 further comprising a curved indent to replace said segmented rail after said segmented rail is removed.

4. The apparatus of claim 1 wherein said segmented rail is pivotable over said platform.

5. The apparatus of claim 1 further comprising a chain and hook to pivot said segmented rail.

6. The apparatus of claim 1 wherein said segmented rail is aligned in a straight line with said side track.

7. The apparatus of claim 1 wherein said segmented rail has a slant angle of 45 degrees relative to said side track.

8. An L-car comprising:
a deck to secure a container or a semi-trailer;
a first dolly attached to said deck to roll on a rail; and
a fixture attached to said deck to mount above a second dolly on another L-car.

9. The L-car of claim 8 wherein said dolly comprises an axle with two wheels.

10. The L-car of claim 8 wherein said container is attached to a chassis.

11. The L-car of claim 8 wherein said another L-car may be separated from said L-car.

12. A method of unloading a container or semi-trailer from an L-car comprising:
moving said L-car from a main line to a side track;
pivoting a segmented rail to a slant angle relative to said side track;
connecting a tractor to said container or semi-trailer; and
pulling said container or semi-trailer off said L-car.

13. The method of claim 12 further comprising sliding said segmented rail over a platform disposed next to said side track.

14. The method of claim 12 further comprising lifting and turning said L-car with a fork-lift truck.

15. The method of claim 12 further comprising lifting and turning said container or semi-trailer with a fork-lift truck.

16. The method of claim 12 further comprising backing up said tractor on a road onto a raised deck.

17. The method of claim 12 further comprising pulling a chain with a hook to pivot said segmented rail.

18. The method of claim 12 further comprising separating said L-car from another L-car on said side track.

19. The method of claim 12 further comprising lowering said L-car to a ground level.

20. The method of claim 12 further lowering said container or semi-trailer to a ground level.
